(19) United States
(12) Patent Application Publication
(10) Pub. No.: US 2003/0106222 A1
(43) Pub. Date: Jun. 12, 2003

(54) Actuation-adjusting structure for handles of scissors

(76) Inventor: Chien-Che Huang, Taipei (TW)

Correspondence Address: Chien-Che Huang, PO Box 82-144, Taipei, TW

(21) Appl. No.: 10/005,674

(22) Filed: Dec. 7, 2001

(51) Int. Cl. B26B 13/20

(52) U.S. Cl. 30/232; 30/341

(57) ABSTRACT

An actuation-adjusting structure for handles of scissors is disclosed. The scissors has blades and handles for holding the blades and are characterized in that the lower section of the blades (shank) is provided with a rough surface or rough ornamental lines, and the top end of the handle for mounting with the lower section of the blades has an insertion slot of an appropriate length, and the lateral side of the handle near the insertion slot is provided with an arch-shaped recess, and a press plate having an arch-shape as that of the recess is adjustably mounted to the recess about a pivot, and the center of the press plate is provided with a holding groove having an edge to mount with the rough surface of the lower section of the blade, thereby the blades are adjustably secured tightly with the handle.

### BACKGROUND OF THE INVENTION

(a) Technical Field of the Invention

The present invention relates to an improved structure of an actuation-adjusting device, and in particular, to an actuation-adjusting structure which allows the securing of the blades to the handles of the scissors and allows the adjustment of the handles with respect to the blades so as to provide a comfortable position for holding the fingers of the user.

(b) Description of the Prior Art

FIG. 4 is a structure of conventional scissors having handles 31 and blades 30. The blades 30 are mounted to each other so that a shear cutting force can be produced. The bottom of the blade 30 is connected with an insertion ring 32 to facilitate the exertion of a force with the fingers. In the conventional scissors, the entire length of the blade together with the insertion ring 32 is normally fixed and when different users use such scissors, as the palms of the users are different from each other, it is not convenient to use or to exert a shearing force. Very often, after a period of use, the fingers of the user become fatigue and it is not comfortable. Accordingly, it is imperatively to design or to exploit scissors, which allows the adjustment of the insertion ring (handles) to comply with the requirement of the users of different palm size.

Taiwan Patent Publication No. 87207500, entitled “Adjustable handles of scissors” discloses a combination of blades and handles of scissors which can be adjusted with respect to each other so as to overcome the drawback of the conventional scissors. The published application relates to a scissors structure comprising blades and handles, and a position slot and a protrusion are provided on the blades. The handles of the scissors after combination can be adjusted to provide an appropriate length of the blade to the handle to comply with the requirements of the user. In this publication, an eccentric cam is used for the positioning of the blades but the positioning also requires the combination of the protrusion and the slot provided on the blades. Due to the fact that the direction of locking of the eccentric cam is opposite to that of the pulling out of the blades after shearing. When the scissors are used in hair cutting, the hair may cause the shearing force of the blade larger than the clamping force of the cam, and the cam may become loose and the blades will be dislocated. Accordingly, it is an object of the present invention to provide an actuation-adjusting structure for handles of scissors, which allows the blades to be securely fastened, and a comfortable operation of the scissors.

### SUMMARY OF THE INVENTION

Accordingly, it is an object of the present invention to provide an actuation-adjusting structure for handles of scissors, wherein the drawbacks of the conventional scissors, such as unsafe structure in shearing and insecure mounting of the blades, can be mitigated.

Yet another object of the present invention is to provide an actuation-adjusting structure for handles of scissors, wherein the lower section of the blades (shank) is provided with a rough surface or rough ornamental lines, and the top end of the handle for mounting with the lower section of the blades has an insertion slot of an appropriate length, and the lateral side of the handle near the insertion slot is provided with an arch-shaped recess, and a press plate having an arch-shape as that of the recess is adjustably mounted to the recess about a pivot, and the center of the press plate is provided with a holding groove having an edge to mount with the rough surface of the lower section of the blade, thereby the blades are adjustably secured tightly with the handle.

A further object of the present invention is to provide an actuation-adjusting structure for handles of scissors, wherein the insert slot for the blade has a sloping and in combination with the rough surface on the shank of the blade and the press plate, and the blades after mounted with the handles will be secured together for safety operation.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective exploded view of the actuation-adjusting structure for handles of scissors of the present invention.

FIG. 2 is a perspective view of the actuation-adjusting structure for handles of scissors of the present invention.

FIG. 3 is a schematic view of the handle insertion module of the actuation-adjusting structure for handles of scissors of the present invention.

FIG. 4 is a perspective view of conventional scissors.

### DETAILED DESCRIPTION OF THE PREFERRED EMBODIMENT

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

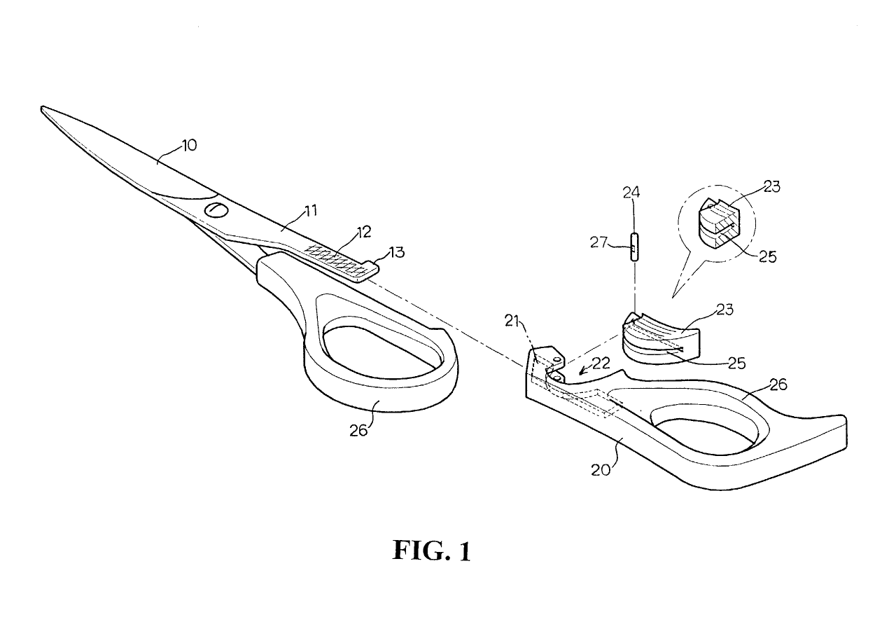

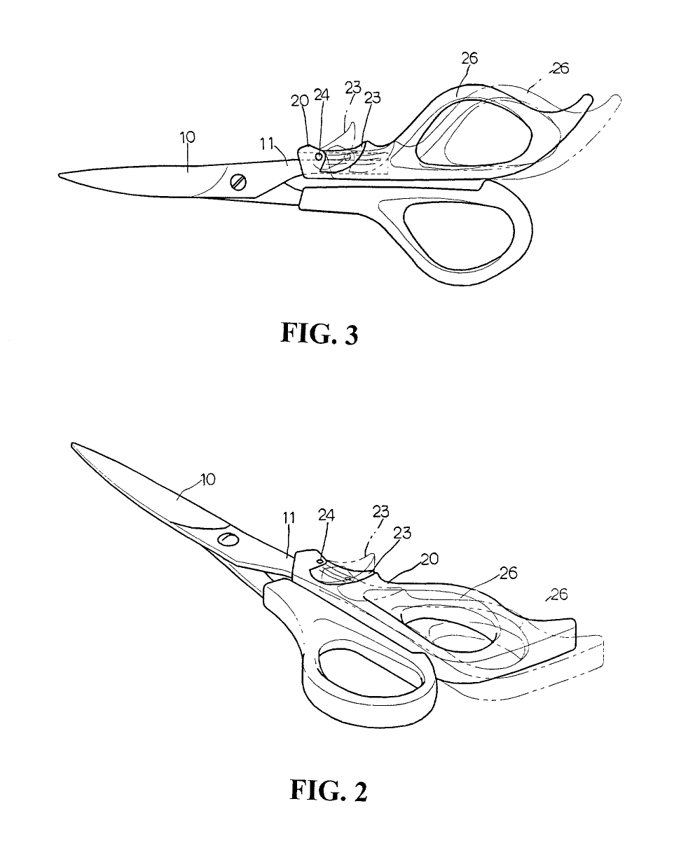

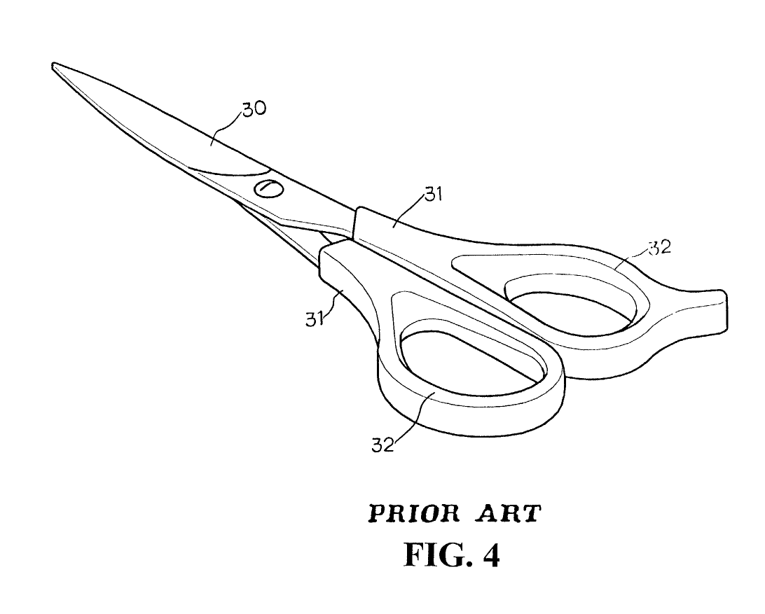

Referring to FIGS. 1 to 3, there is shown an actuation-adjusting structure for handles of scissors comprising metallic blades 10 and handles 20, wherein the lower portion, i.e., the shank 11, of the metallic blades 10 are mounted into the top portion of the handles 20, which made from plastic materials. The surface of the wider sides of the shank 11 is provided with a rough surface 12, crisscross lines or other ornamental lines to provide a larger frictional force when the shank 11 is inserted into the handles 20. The handle 20 has an insertion ring 26, which provides the fingers of the user to exert a shearing force to the blades 10, and the top end of the handle 20 is provided with an insertion slot 21 of an appropriate length, and the width of the slot 21 is similar to that of the blade 10. An arch-shaped recess 22 is provided to the top end of the handle 20, close to the insertion slot 21, and a press plate 23 having the shape of the recess 22 is used to fit with the recess 22. A pivot 24, which is a short rod, is used for pivotally mounting of the press plate 23 to the handles and the blades 10. A holding slot 25 is provided at the edge of the arch-shaped press plate 23 and is corresponding to the insertion slot 21.

The eccentrically mounted pivot 24 allows the press plate 23 to move about the pivot 24 and to fasten the handle 20 to the rough surface 12 of the shank 11 so that the blade 10 provides a shear force for cutting.

In the present invention, the end of the shank 11 has a wider engaging end 13, which is an element indicating the limit of the blade 10. The handles can be adjusted to move to the end of the blades 10 until the engaging end 13 touches the pivot 24. A flat surface 27 is provided to the pivot 24 so that the flat surface 27 can urge against the end surface of the shank 11 when the press plate 23 presses against the shank 11 to form the top point when the blades 11 are closed to each other. This also prevents the pivot 24 from dislocation. With the combination of the rough surface 12, and the holding slot 25, the blades 10 and the handles 20 are secured together. The arch-shaped edge of the press plate 23 and the insertion ring 26 provide a comfortable holding of the fingers of the user so that a shear cutting force can be produced.

In accordance with the present invention, in operation, when the blades 10 produce a cutting shear, the blades 10 are slightly tightened in the direction of cutting. Accordingly, the blades 10 will be secured without dislocation from each other. In the present preferred embodiment, the holding slot 25 has a slope, which facilitates the mounting of the blades 10 with the handles 20. Together with the adjustment of the handles 20 the user can use the scissors comfortably and an effective shearing force is thus produced.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. An actuation-adjusting structure for handle of scissors having blades and handles to hold the blades, characterized in that the lower section of the blades (shank) is provided with a rough surface or rough ornamental lines, and the top end of the handle for mounting with the lower section of the blades has an insertion slot of an appropriate length, and the lateral side of the handle near the insertion slot is provided with an arch-shaped recess, and a press plate having an arch-shape as that of the recess is adjustably mounted to the recess about a pivot, and the center of the press plate is provided with a holding groove having an edge to mount with the rough surface of the lower section of the blade, thereby the blades are adjustably secured tightly with the handle.

2. The actuation-adjusting structure of claim 1, wherein the pivot is eccentrically designed to allow the blades to produce a shear cutting force and the blades are firmly secured with each other.

3. The actuation-adjusting structure of claim 1, wherein the lower section of the blade has a rough surface having a plurality of parallel lines, crisscross lines or ornamental lines, or engraved lines.

4. The actuation-adjusting structure of claim 1, wherein the end of the shank of the blade has a wider engaging end, which is the limit of the blade.

5. The actuation-adjusting structure of claim 1, wherein the pivot for the press plate is provided with a flat surface section at the middle section thereof.
